(19) United States
(12) Patent Application Publication
(10) Pub. No.: US 2016/0202727 A1
(43) Pub. Date: Jul. 14, 2016

(54) ELECTRONIC APPARATUS

(71) Applicant: Kabushiki Kaisha Toshiba, Tokyo (JP)

(72) Inventors: Vic LIN, Sung-Shan Chiu Taipei (TW); Brad CHIU, Sung-Shan Chiu Taipei (TW); Ryusuke KURIMOTO, Uji Kyoto (JP); Yusuke KAWAI, Ota Tokyo (JP); Jonas BERGFLEDT, Storgatan Stockholm (SE); Thomas SCHAAD, Storgatan Stockholm (SE); Stefan WENNERSTROM, Storgatan (SE); Naoto NAKAMURA, Storgatan Stockholm (SE)

(21) Appl. No.: 15/060,510

(22) Filed: Mar. 3, 2016

Related U.S. Application Data
(63) Continuation of application No. PCT/JP2013/084375, filed on Dec. 20, 2013.

(51) Int. Cl. G06F 1/16

(52) U.S. Cl. CPC G06F 1/1637; G06F 1/1681

(57) ABSTRACT

According to one embodiment, an electronic apparatus includes a first module, a second module and a hinge. The first module includes a first face, a second face opposite the first face, a first end between the first face and the second face, a second end opposite the first end, and a displaying portion on the first face displaying an image. The second module includes a coupling module that has a third end and a fourth end opposite the third end, and an input module that has a fifth end detachably connected to the fourth end of the coupling module. The hinge connects the first end and the third end to allow the coupling module to move between a first position at which the second module covers the displaying portion and a second position at which the second module covers the second face.

### CROSS-REFERENCE TO RELATED APPLICATIONS

This application is a continuation of International Application No. PCT/JP2013/084375, filed on Dec. 20, 2013, the entire contents of which are incorporated herein by reference.

### FIELD

An embodiment described herein relates generally to an electronic apparatus.

### BACKGROUND

An electronic apparatus such as a portable computer includes an input device such as a keyboard, a touch pad, and a pointing stick. The input device is connected to a display such as a liquid crystal display (LCD) that displays images. For key inputs from a remote position from the display, for example, an external keyboard is used.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of a portable computer according to an embodiment;

FIG. 2 is another exemplary perspective view of the portable computer in the embodiment from a different direction from that in FIG. 1;

FIG. 3 is an exemplary side view of the portable computer in the embodiment;

FIG. 4 is an exemplary perspective view of the portable computer in the embodiment excluding some portions of first to third housings;

FIG. 5 is an exemplary perspective view of a display module and a base module in the embodiment;

FIG. 6 is an exemplary back view of a keyboard module in the embodiment;

FIG. 7 is an exemplary side view of a part of the portable computer in a tablet mode in the embodiment;

FIG. 8 is an exemplary side view of the portable computer in a separate mode in the embodiment; and

FIG. 9 is an exemplary side view of the portable computer in a tent mode in the embodiment.

### DETAILED DESCRIPTION

In general, according to one embodiment, an electronic apparatus includes a first module, a second module and a hinge. The first module includes a first face, a second face opposite the first face, a first end between the first face and the second face, a second end opposite the first end, and a displaying portion provided on the first face and configured to display an image. The second module includes a coupling module that has a third end and a fourth end opposite the third end, and an input module that has a fifth end configured to be detachably connected to the fourth end of the coupling module. The hinge connects the first end of the first module and the third end of the coupling module to allow the coupling module to move between a first position at which the second module covers the displaying portion and a second position at which the second module covers the second face.

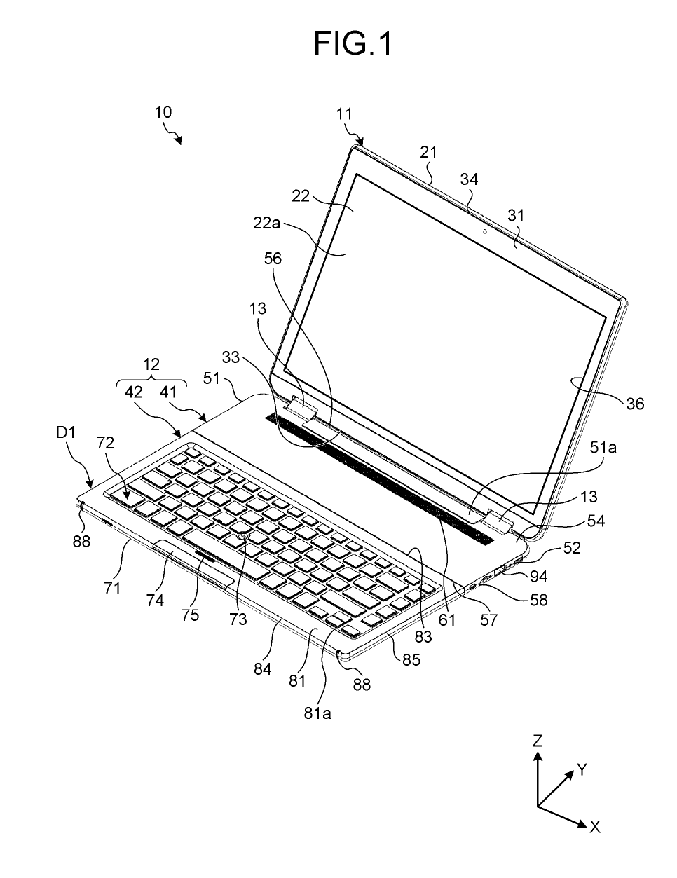

The following describes an embodiment with reference to FIGS. 1 to 9. In the present specification, directions or positions are basically defined from a user's point of view as follows: a user side is front, the side remote from the user is back the user's left side is leftward, the user's right side is rightward, the user's upper side is upward, and the user's lower side is downward. The elements according to the embodiment and the explanations thereof may be expressed differently. Any other different expressions and explanations of the elements than the ones described herein are applicable. In addition, any expression of the elements and explanations thereof, which are not described in a plurality of expressions, other than the expressions described herein are applicable.

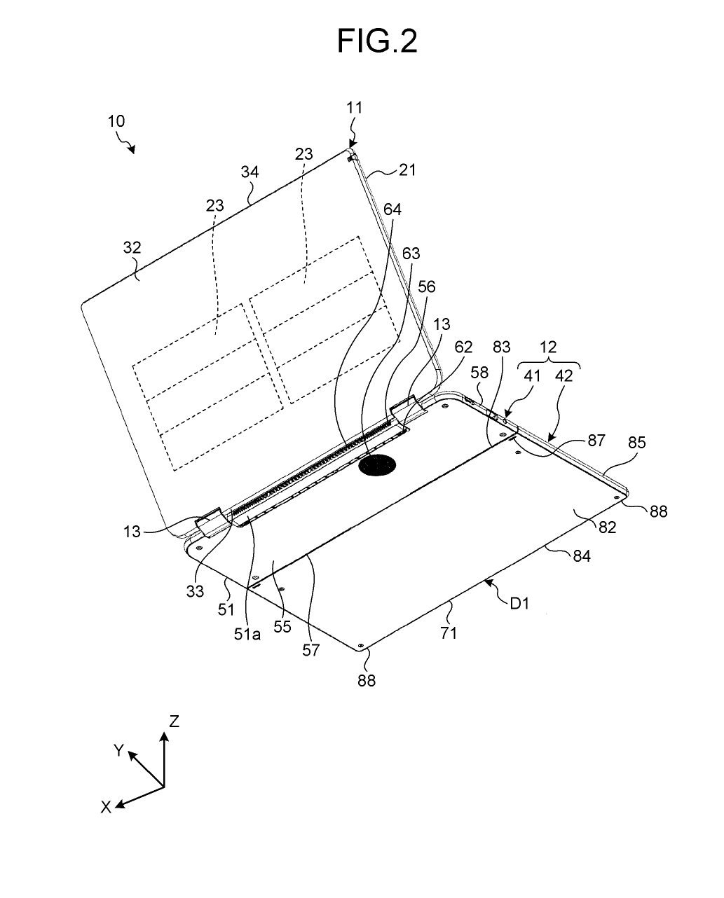

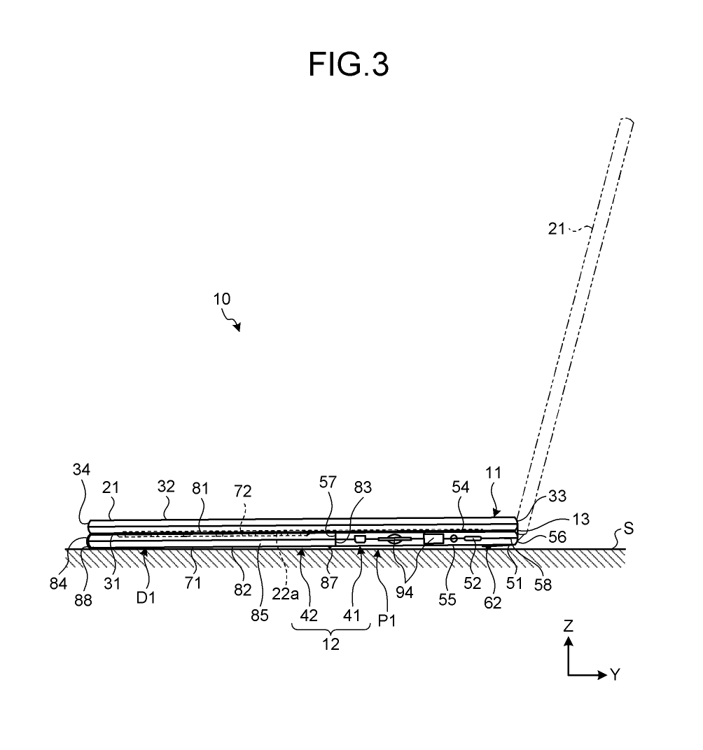

FIG. 1 is a perspective view of a portable computer 10. FIG. 2 is a perspective view of the portable computer 10 from a different direction from that in FIG. 1. FIG. 3 is a side view of the portable computer 10.

The portable computer 10 is an example of an electronic apparatus. The electronic apparatus should not be limited to the portable computer 10. Examples of the electronic apparatus may include a personal computer, a television receiver, a display, a tablet device, a mobile phone, a smartphone, a mobile game machine, and a camera.

As illustrated in FIG. 1, the portable computer 10 includes a display 11, a base 12, and two hinges 13. The display 11 is an example of a first module, and can also be referred to as a display unit, a module, or a unit. The base 12 is an example of a second module, and can also be referred to as a body, a module, or a unit. The hinges 13 can also be referred to as a coupling portion, a connecting portion, a rotational portion, an intermediate portion, or an interposed portion.

In the specification X axis, Y axis, and Z axis are defined as illustrated in the drawings. The X, Y, and Z axes are orthogonal to each other. The X axis is along the width (length of a longer side) of the base 12, for example. The Y axis is along the depth (length of a shorter side) of the base 12, for example. The Z axis is along the thickness (vertical length) of the base 12, for example.

The display 11 includes a first housing 21 and a display module 22. As illustrated in FIG. 2, the display 11 further includes a plurality of first batteries 23. The first housing 21 can also be referred to as an exterior, a member, or a wall, for example. The display module 22 can also be referred to as a display device, a display unit, a part, or a member, for example.

As illustrated in FIGS. 1 to 3, the first housing 21 is a flat, approximately rectangular parallelepiped box. The first housing 21 is basically made from a magnesium alloy, for example. The first housing 21 may be made from a different material.

The first housing 21 has a front face 31, a back face 32, a bottom end 33, and a top end 34. The front face 31 is an example of a first face. The back face 32 is an example of a second face. The bottom end 33 is an example of a first end. The top end 34 is an example of a second end. The bottom end 33 and the top end 34 can also be referred to as edges, rims, or portions, for example.

In the specification, the terms that represent directions including front, back, top, and bottom are used on the basis of a state (clam shell mode) of the portable computer 10 illustrated in FIG. 1. Therefore, the front face 31 is not always on the user side while the bottom end 33 is not always located on the user's lower side.

The front face 31 has an approximately flat rectangular (quadrangular) shape. The front face 31 is made of a transparent glass plate that covers a bezel (frame), for example. The bezel has a display opening 36. The display opening 36 is an approximately rectangular hole. The display opening 36 is closed with the glass plate. The back face 32 is opposite the front face 31.

The bottom end 33 includes an end face of the first housing 21. The end face is located between the bottom edge of the front face 31 and the bottom edge of the back face 32. The end face intersects the front face 31 and the back face 32. The top end 34 is opposite the bottom end 33. The top end 34 includes another end face of the first housing 21. The end face is located between the top edge of the front face 31 and the top edge of the back face 32. The end face intersects the front face 31 and the back face 32.

The display module 22 is a capacitive in-cell type touch panel, for example. The display module 22 should not be limited to this example and may be a different element that displays images such as a liquid crystal display (LCD) or an organic electroluminescence (OEL) display to which a touch panel is attached, for example.

The display module 22 is accommodated in the first housing 21. The display module 22 includes a screen 22a. The screen 22a is an example of a displaying portion, and can also be referred to as a displaying face or portion. The screen 22a is exposed outside the first housing 21 through the display opening 36 and the glass plate to display images. Thus, the screen 22a of the display module 22 displaying images is on the front face 31. In the specification, the “image” includes a still image, a moving image, and a monochrome image.

The display module 22 can detect a user's finger touching the screen 22a or the glass plate covering the display opening 36, for example. The display module 22 is operated with a user's finger to input information to the portable computer 10. The display module 22 is thus a display device as well as an input device.

The first batteries 23 are accommodated in the first housing 21. The first batteries 23 are lithium-ion secondary batteries, for example. The first batteries 23 may be a different type of batteries. The first batteries 23 are a power source of the portable computer 10.

The base 12 includes a base unit 41 and a keyboard module 42. The base unit 41 is an example of a coupling module, and can also be referred to as a connecting module, a docking module, a rotational module, a support module, a portion, or a part, for example. The keyboard module 42 is an example of an input module, and can also be referred to as a connecting module, a docking module, a detachable module, a portion, or a part, for example.

The base unit 41 includes a second housing 51 and a power button 52. The second housing 51 can also be referred to as an exterior, a member, or a wall, for example. The power button 52 is an example of a starter, and can also be referred to as a button or an operation module, for example.

The second housing 51 is a flat, approximately rectangular parallelepiped box. The second housing 51 is basically made from a magnesium alloy, for example. The second housing 51 may be made from a different material.

The second housing 51 has a first top face 54, a first bottom face 55, a first back end 56, a first front end 57, and two first side faces 58. The first bottom face 55 is an example of a fifth face. The first back end 56 is an example of a third end. The first front end 57 is an example of a fourth end. The first back end 56 and the first front end 57 can also be referred to as ends, edges, or portions, for example.

The first top face 54 has an approximately flat rectangular shape. The first top face 54 has a plurality of holes 61. The base unit 41 is accommodated in the second housing 51 and further includes a speaker that emits sounds through the holes 61.

The first bottom face 55 is opposite the first top face 54. The first bottom face 55 is provided with a plurality of first legs 62. The first legs 62 are protrusions from the first bottom face 55, made of a synthetic rubber, for example. As illustrated in FIG. 3, the first legs 62 are in contact with a mount face S on which the portable computer 10 is placed and support the base unit 41. The mount face S is the top surface of a desk, for example.

The first bottom face 55 has a plurality of air intakes 63. Each of the air intakes 63 is an example of a first vent. The air intakes 63 can also be referred to as holes or openings, for example. The air intakes 63 communicate with the inside of the second housing 51.

The first back end 56 includes an end face of the second housing 51. The end face is located between the back edge of the first top face 54 and the back edge of the first bottom face 55. The end face intersects the first top face 54 and the first bottom face 55.

The first back end 56 has a plurality of air outtakes 64. Each of the air outtakes 64 is an example of a second vent. The air outtakes 64 can also be referred to as holes, openings, or slits, for example. The air outtakes 64 communicate with the inside of the second housing 51.

The first front end 57 is opposite the first back end 56. The first front end 57 includes an end face of the second housing 51. The end face is located between the front edge of the first top face 54 and the front edge of the first bottom face 55. The end face intersects the first top face 54 and the first bottom face 55.

One of the two first side faces 58 is located between the right edge of the first top face 54 and the right edge of the first bottom face 55 while the other first side face 58 is located between the left edge of the first top face 54 and the left edge of the first bottom face 55. The first side faces 58 are line symmetric to the center of the thickness (along the Z axis) of the second housing 51 between the first top face 54 and the first bottom face 55. The first side faces 58 are arc-like curved faces, for example.

The power button 52 is provided on the one first side surface 58. By a user's manipulation of the power button 52, the portable computer 10 starts up. The startup of the portable computer 10 should not be limited to turning-on of the portable computer 10 or power source. For example, the startup also includes a recovery of the portable computer 10 from a sleep state.

The keyboard module 42 includes a third housing 71, a keyboard 72, a pointing stick 73, a button 74, and an ejection lever 75. Each of the keyboard 72, the pointing stick 73, and the button 74 is example of an operation module. They can also be referred to as an input module, an input device, or an interface. The ejection lever 75 is an example of a releaser, and can also be referred to as a sliding module or an operation module, for example.

The third housing 71 a flat, approximately rectangular parallelepiped box. The third housing 71 is basically made from a magnesium alloy, for example. The third housing 71 may be made from a different material.

The third housing 71 has a second top face 81, a second bottom face 82, a second back end 83, a second front end 84, and two second side faces 85. The second top face 81 is an example of a third face. The second bottom face 82 is an example of a fourth face. The second back end 83 is an example of a fifth end. The second front end 84 is an example of a sixth end. The second back end 83 and the second front end 84 can also be referred to as ends, edges, or portions, for example.

The second top face 81 with a depression 81a has a rectangular shape. The keyboard 72, the pointing stick 73, the button 74, and the ejection lever 75 are provided on the second top face 81.

The keyboard 72 and the pointing stick 73 are arranged in the depression 81a. The keyboard 72, the pointing stick 73, and the button 74 are operated by the user so as to input information to the portable computer 10. The ejection lever 75 is located between the keyboard 72 and the button 74.

The second bottom face 82 is opposite the second top face 81. A plurality of second legs 87 are provided on the second bottom face 82. The second legs 87 are protrusions from the second bottom face 82, made of a synthetic rubber, for example. As illustrated in FIG. 3, the second legs 87 are in contact with the mount face S on which the portable computer 10 is placed, and support the keyboard module 42.

The second back end 83 includes an end face of the third housing 71. The end face is located between the back edge of the second top face 81 and the back edge of the second bottom face 82. The end face intersects the second top face 81 and the second bottom face 82.

The second front end 84 is opposite the second back end 83. The second front end 84 includes an end face of the third housing 71. The end face is located between the front edge of the second top face 81 and the front edge of the second bottom face 82. The end face intersects the second top face 81 and the second bottom face 82. The button 74 is adjacent to the second front end 84.

A plurality of third legs 88 are provided on the second front end 84. The third legs 88 are protrusions from the second top face 81, the second bottom face 82, and the end face of the second front end 84, made of a synthetic rubber, for example. As illustrated in FIG. 3, the third legs 88 are in contact with the mount face S on which the portable computer 10 is placed, and support the keyboard module 42.

One of the two second side surfaces 85 is located between the right edge of the second top face 81 and the right edge of the second bottom face 82 while the other second side face 85 is located between the left edge of the second top face 81 and the left edge of the second bottom face 82. The second side faces 85 are line symmetric to the center of the thickness (along the Z axis) of the third housing 71 between the second top face 81 and the second bottom face 82. The second side faces 85 are arc-like curved faces having the same curvature radius as the first side surfaces 58, for example.

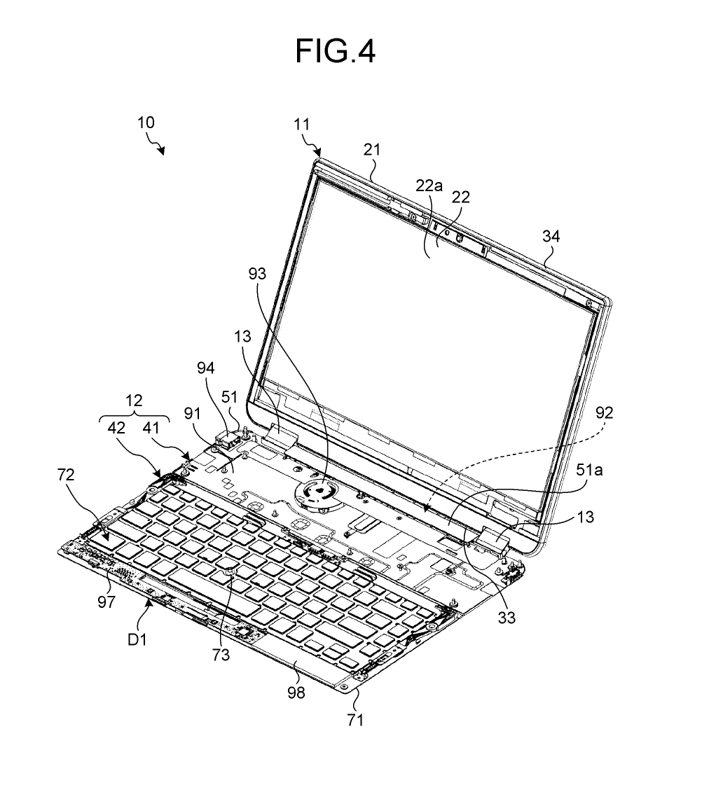

FIG. 4 is a perspective view of the portable computer 10 from which some portions of the first housing 21, the second housing 51, and the third housing 71 are excluded. As illustrated in FIG. 4, the base unit 41 further includes a board 91, a first communication module 92, a cooling module 93, and a plurality of input-output parts 94. The board 91 is an example of a module, and can also be referred to as a part, for example.

The board 91, the first communication module 92, the cooling module 93, and the input-output parts 94 are accommodated in the second housing 51. The board 91, the first communication module 92, the cooling module 93, and the input-output parts 94 may be accommodated in the first housing 21 of the display 11, for example.

The board 91 is a printed circuit board (PCB), for example. The board 91 may be a flexible printed circuit board (FPC). The module or the board 91 may be a different part. Various electronic parts or elements such as a central processing unit (CPU) and a memory are mounted on the board 91.

The first communication module 92 performs short-range wireless communication, for example. The first communication module 92 includes a circuit board on which various electronic parts or elements are mounted, and an antenna, for example. The first communication module 92 is electrically connected to the board 91 to transmit and receive electrical signals to/from the CPU, for example.

The second housing 51 includes an antenna cover 51a that covers the antenna of the first communication module 92. The antenna cover 51a is made from an insulating material such as a synthetic resin and a part of the second housing 51. The antenna transmits and receives radio waves through the antenna cover 51a. Apart of the antenna cover 51a protrudes from the first top face 54 and the first bottom face 55.

The cooling module 93 is a centrifugal fan, for example. The cooling module 93 is thermally connected to the CPU through a heat pipe, for example. The cooling module 93 is disposed corresponding to the air intakes 63. The cooling module 93 absorbs air from outside the second housing 51 through the air intakes 63 and discharges air from the air outtakes 64. The cooling module 93 thus cools the CPU and the inside of the second housing 51. The cooling module 93 may absorb outside air through the air outtakes 64 and discharge air from the air intakes 63.

The input-output parts 94 are mounted on the board 91. The input-output parts 94 include universal serial bus (USB) connectors, local area network (LAN) connectors, red-green-blue (RGB) connectors, audio terminals, a power connector, and a memory card connector, for example. The input-output parts 94 are exposed outside the second housing 51 from the openings of the first side surface 58.

The keyboard module 42 further includes a second communication module 97 and a second battery 98. The second battery 98 is an example of a battery, and can also be referred to as a power source, a charging-discharging module, or a power supply module, for example. The second communication module 97 and the second battery 98 are accommodated in the third housing 71.

The second communication module 97 performs short-range wireless communication with the first communication module 92, for example. The second communication module 97 includes a circuit board on which various electronic parts or elements are mounted, and an antenna, for example. The second communication module 97 receives electrical signals from the keyboard 72, the pointing stick 73, and the button 74.

The keyboard module 42 inputs information to the CPU on the board 91 via the first communication module 92 and the second communication module 97, for example. The second communication module 97 transmits information input by the user with the keyboard 72 to the first communication module 92 through the short-range wireless communication, for example. The first communication module 92 inputs the received information to the CPU on the board 91. The first communication module 92 and the second communication module 97 may communicate with each other by another scheme such as infrared-ray communication in place of the short-range wireless communication.

The second battery 98 is a lithium-ion secondary battery, for example. The second battery 98 may be a different type of battery. The second battery 98 works for a power source of the keyboard module 42.

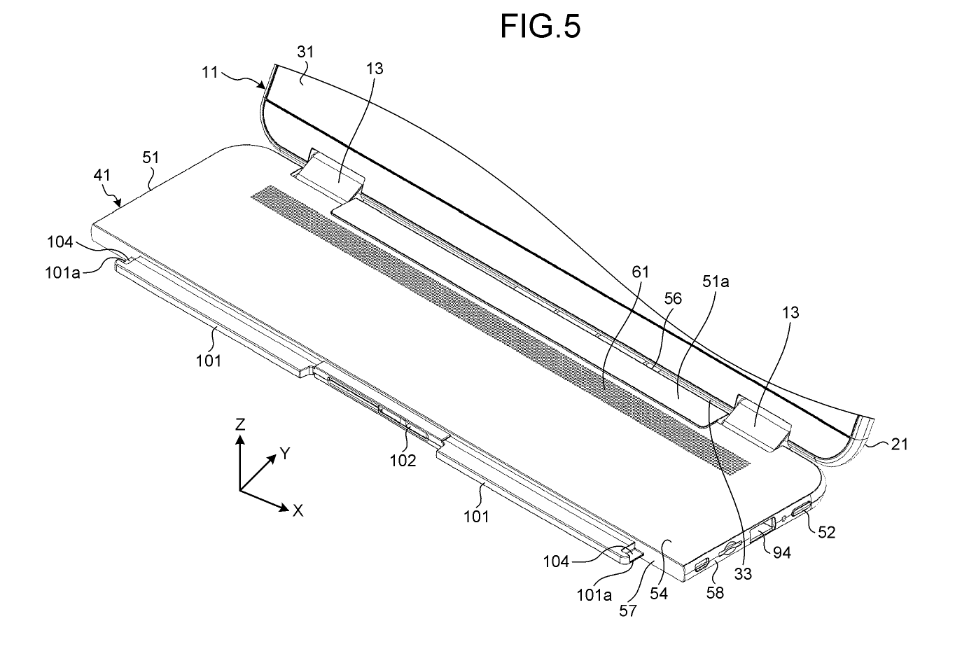

FIG. 5 is a perspective view of a part of the display 11 and the base unit 41. As illustrated in FIG. 5, two protrusions 101 and a first terminal 102 are provided on the first front end 57. Each of the protrusions 101 is an example of a first fitting portion. The protrusions 101 can also be referred to as inserting portions, supporting portions, or reinforcing portions, for example.

The protrusions 101 each have an approximately rectangular platy shape extending in the X axis direction. The protrusions 101 are a part of the second housing 51, made from a magnesium alloy the same as the second housing 51. The protrusions 101 may be made from a different material from that of the second housing 51. The protrusions 101 protrude from the end face of the first front end 57 in the Y axis direction. The two protrusions 101 are aligned in the X axis direction.

The protrusions 101 each have a cutout 104. The cutouts 104 are an example of a first engaging portion. The cutouts 104 can also be referred to as concaves, recesses, or catch portions. The cutouts 104 are provided on side ends 101a of the protrusions 101. The side ends 101a are the ends of the protrusions 101 in the X axis direction. The side ends 101a face in the opposite directions.

The first terminal 102 is disposed on the end face of the first front end 57. The first terminal 102 includes a plurality of positive and negative electrodes alternately arranged, for example. The first terminal 102 is electrically connected to the first batteries 23 and the board 91.

The first terminal 102 is located between the two protrusions 101. The first terminal 102 is disposed on either the right or left side of the center (between the two first side surfaces 58) of the first front end 57 in the X axis direction.

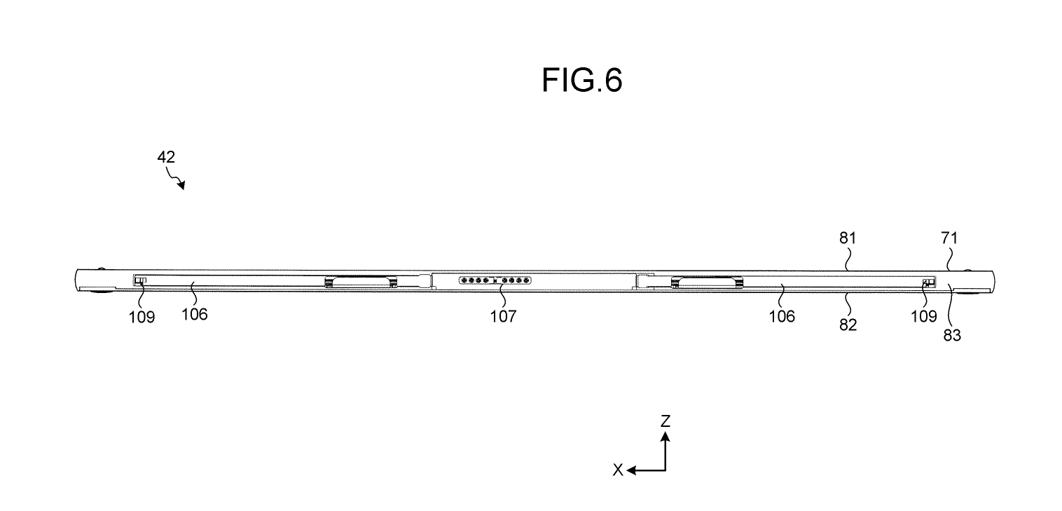

FIG. 6 is a back view of the keyboard module 42. As illustrated in FIG. 6, two recesses 106 and a second terminal 107 are provided on the second back end 83. Each of the recesses 106 is an example of a second fitting portion. The recesses 106 can also be referred to as openings, holes, slits, or depressions, for example.

Each of the recesses 106 is an opening of an approximately rectangular shape, extending in the X axis direction. The recesses 106 are located at the second back end 83. The two recesses 106 are arranged corresponding to the protrusions 101 and aligned in the X axis direction.

Hooks 109 are provided in the recesses 106, respectively. Each of the hooks 109 is an example of a second engaging portion. The hooks 109 can also be referred to as hooking portions, fitting portions, fixing portions, or attaching portions. The hooks 109 are positioned corresponding to the cutouts 104 and protrude from the inner surfaces of the recesses 106 in the X axis direction. The hooks 109 can be retracted from the inner surfaces of the recesses 106.

The second terminal 107 is disposed on the end face of the second back end 83. The second terminal 107 includes a plurality of positive and negative electrodes alternately arranged, for example. The second terminal 107 is electrically connected to the second battery 98.

The second terminal 107 is located between the two recesses 106. The second terminal 107 is disposed on either the right or left side of the center (between the two second side surfaces 85) of the second back end 83 in the X axis direction.

As illustrated in FIG. 1, the second back end 83 of the keyboard module 42 is detachably connected to the first front end 57 of the base unit 41. The keyboard module 42 is joined with the base unit 41 while aligned with the base unit 41 in a direction (along the Y axis) from the first back end 56 toward the first front end 57.

To join the keyboard module 42 with the base unit 41, the protrusions 101 are fitted into the recesses 106. By the fitting-in of the protrusions 101 and the recesses 106, the keyboard module 42 is supported on the base unit 41.

When the protrusions 101 fit in the recesses 106, the hooks 109 in the recesses 106 are engaged with the cutouts 104 of the protrusions 101. The engagement of the hooks 109 with the cutouts 104 works to prevent the keyboard module 42 from being detached from the base unit 41.

The two hooks 109 are connected to the ejection lever 75 via a plurality of links, for example. The hooks 109 are released from the cutouts 104 by a user's manipulation of the ejection lever 75. In other words, the ejection lever 75 operates the hooks 109.

When the keyboard module 42 is joined with the base unit 41, the first terminal 102 is electrically connected to the second terminal 107. The second battery 98 is charged through the first terminal 102 and the second terminal 107 electrically connected to each other. For example, power is supplied to the power connector of the base unit 41 from an outlet and supplied to the second battery 98 through the first terminal 102 and the second terminal 107. Power of the first batteries 23 is supplied to the second battery 98 through the base unit 41, the first terminal 102, and the second terminal 107.

The hinges 13 connect the bottom end 33 of the display 11 and the first back end 56 of the base unit 41. One end of each hinge 13 is rotatably connected to the bottom end 33 of the first housing 21 of the display 11. The other end of each hinge 13 is rotatably connected to the first back end 56 of the second housing 51 of the base unit 41. The antenna cover 51a in the second housing 51 is located between the two hinges 13.

The hinges 13 are rotatable 180 degrees between a vertically protruding position from the front surface 31 and a vertically protruding position from the back surface 32 of the first housing 21 of the display 11. Furthermore, the hinges 13 are rotatable 180 degrees between a vertically protruding position from the first top face 54 and a vertically protruding position from the first bottom face 55 of the second housing 51 of the base unit 41. The hinges 13 thus function to rotatably connect the base unit 41 to the display 11 360 degrees.

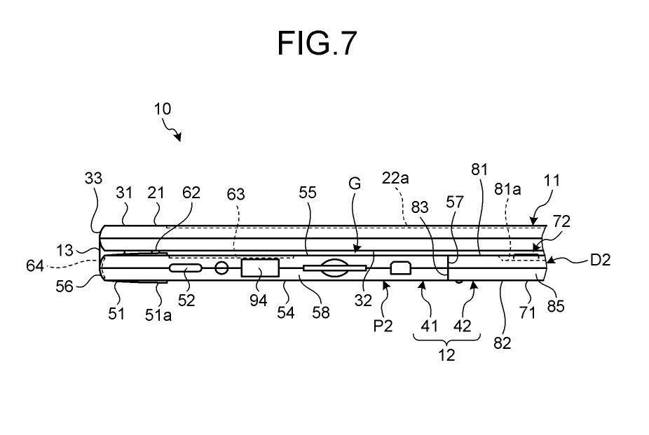

FIG. 7 is a side view of a part of the portable computer 10 when the base unit 41 is rotated from the position indicated by the solid line in FIG. 3 by approximately 360 degrees (in a tablet mode). The hinges 13 allow the base unit 41 to rotate between a first position P1 indicated by the solid line in FIG. 3 and a second position P2 illustrated in FIG. 7. The first position P1 can be also referred to as a closed position. The second position P2 can be also referred to as a reverse position.

As illustrated in FIG. 3, when the base unit 41 is at the first position P1, the base 12 covers the front face 31 of the first housing 21. The base 12 thus covers the screen 22a on the display module 22. Further, when the base unit 41 is at the first position P1, the first top face 54 of the second housing 51 and the second top face 81 of the third housing 71 oppose the front face 31 of the first housing 21.

The distance between the bottom end 33 and the top end 34 of the display 11 is larger than the distance between the first back end 56 and the first front end 57 of the base unit 41. In addition, the distance between the bottom end 33 and the top end 34 of the display 11 is substantially equal to the distance between the first back end 56 of the base unit 41 and the second front end 84 of the keyboard module 42.

While the keyboard module 42 is detached from the base unit 41, the screen 22a on the display module 22 is partially covered with the base unit 41 at the first position P1. The screen 22a on the display module 22 is also partially exposed.

As illustrated in FIG. 7, when the base unit 41 is at the second position P2, the base 12 covers the back face 32 of the first housing 21. When the base unit 41 is at the second position P2, the first bottom face 55 of the second housing 51 opposes the back face 32 of the first housing 21. The screen 22a on the display module 22 is now fully exposed.

When the base unit 41 is at the second position P2, the first legs 62 and the third legs 88 abut on the back face 32 of the first housing 21. As a result, a gap G occurs between the display 11 and the base 12.

The air intakes 63 face the gap G between the back face 32 of the first housing 21 and the first bottom face 55 of the second housing 51. That is, the air intakes 63 are not closed with the first housing 21 but open. The cooling module 93 absorbs air in the gap G through the air intakes 63.

In the clam shell mode illustrated in FIG. 1 the keyboard module 42 is joined with the base unit 41 in a first direction D1. When the base unit 41 is at the first position P1 and the keyboard module 42 is in the first direction D1, the second top face 81 of the third housing 71 opposes the front face 31 of the first housing 21.

In the tablet mode illustrated in FIG. 7 the keyboard module 42 is joined with the base unit 41 in a second direction D2. The second direction D2 is reverse to the first direction D1. When the base unit 41 is at the second position P2 and the keyboard module 42 is in the second direction D2, the second top face 81 of the third housing 71 opposes the back face 32 of the first housing 21.

As described above, the keyboard module 42 is joined with the base unit 41 in the first direction D1 or the second direction D2. Irrespective of the first or second direction D1, D2 of the keyboard module 42 joined with the base unit 41, the protrusions 101 are fitted into the recesses 106 and the hooks 109 are engaged with the cutouts 104.

When the keyboard module 42 is joined with the base unit 41 in the first direction D1, one first side face 58 becomes continuous with one second side face 85. When the keyboard module 42 is joined with the base unit 41 in the second direction D2, the one first side face 58 also becomes continuous with the other second side face 85. Thus, the second side faces 85 become continuous with the first side face 58 irrespective of the first direction D1 or the second direction D2 of the keyboard module 42 joined with the base unit 41.

When the keyboard module 42 is joined with the base unit 41 in the first direction D1, the first terminal 102 faces the second terminal 107 and is electrically connected to the second terminal 107. Meanwhile, when the keyboard module 42 is joined with the base unit 41 in the second direction D2, the first terminal 102 faces the second back end 83 of the third housing 71. The first terminal 102 and the second terminal 107 are, thus, electrically disconnected.

Moreover, when the keyboard module 42 is joined with the base unit 41 in the second direction D2, the first terminal 102 and the second terminal 107 do not contact the other members. However, the first terminal 102 and the second terminal 107 may contact an insulating member.

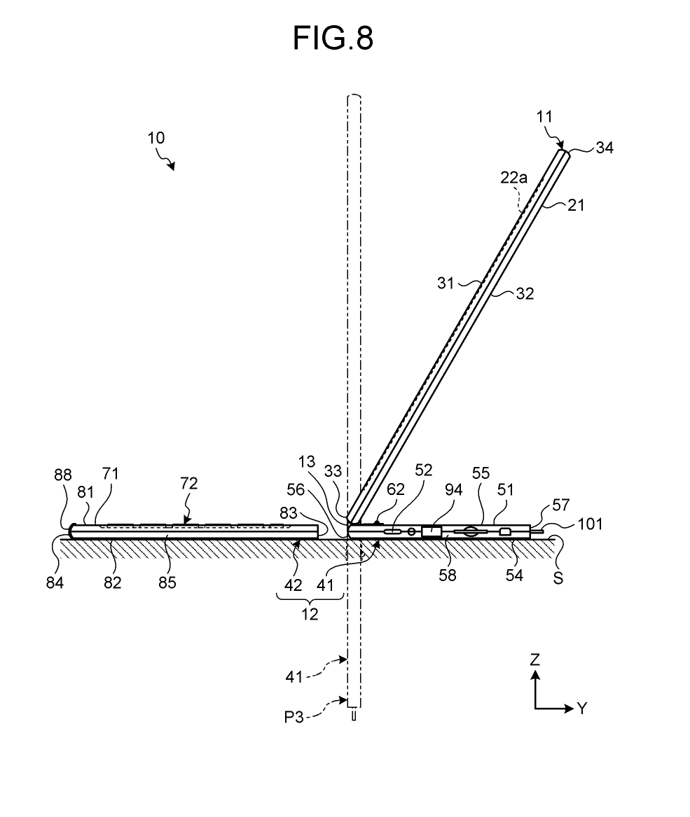

FIG. 8 is a side view of the portable computer 10 when the keyboard module 42 is detached and the base unit 41 supports the display 11 (in a separate mode). As illustrated in FIG. 8, the keyboard module 42 can be used in a detached state from the base unit 41.

In the separate mode, the base unit 41 is located between the second position P2 and a third position P3 indicated by the two-dot chain line in FIG. 8. The third position P3 is between the first position P1 and the second position P2. When the base unit 41 is at the third position P3, the bottom end 33 of the first housing 21 and the first back end 56 of the second housing 51 face each other.

In the separate mode, the first top face 54 of the second housing 51 contacts the mount face S. Thereby, the base unit 41 supports the display 11. The hinges 13 work to prevent the display 11 from rotating by its own weight.

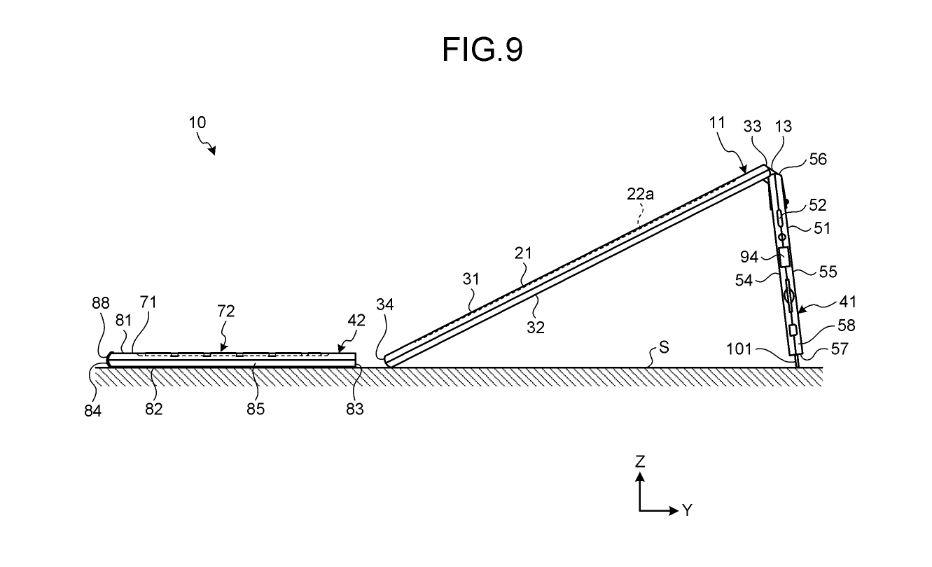

FIG. 9 is a side view of the portable computer 10 supported by the base unit 41 and the display 11 with the keyboard module 42 detached (in a tent mode).

In the tent mode, the base unit 41 is located between the second position P2 and the third position P3. The top end 34 of the first housing 21 abuts on the mount face S. In addition, the protrusions 101 on the first front end 57 of the second housing 51 contact the mount face S. The top end 34 of the display 11 and the protrusions 101 of the base unit 41 work to support the portable computer 10. The tilt of the display 11 relative to the mount face S in the tent mode is smaller than that in the separate mode.

In the display module 22 in the tent mode, the bottom end 33 comes at the top while the top end 34 comes at the bottom. The CPU on the board 91 detects that the portable computer 10 is in the tent mode with an acceleration sensor, for example. In the tent mode, the display module 22 displays an image on the screen 22a in such a direction that the top end 34 is located below the image while the bottom end 33 is located above the image.

In the display module 22 in the clam shell mode, the bottom end 33 comes at the bottom while the top end 34 comes at the top. The CPU on the board 91 detects that the portable computer 10 is in the clam shell mode. In the clam shell mode the display module 22 displays an image on the screen 22a in such a direction that the top end 34 is located above the image while the bottom end 33 is located below the image.

The direction of the image on the display module 22 may be changed by a user's operation of the portable computer 10, for example. The CPU on the board 91 may detect that the portable computer 10 is in the tent mode on the basis of rotational angles of the hinges 13, for example.

In the portable computer 10 in the embodiment, the base unit 41 is movably joined with the display 11 via the hinges 13. The second back end 83 of the keyboard module 42 is detachably connected to the first front end 57 of the base unit 41. As a result, the keyboard module 42 can be used in a detached state from the base unit 41. This makes it possible to use the portable computer 10 in various forms.

While the keyboard module 42 is detached from the base unit 41, the screen 22a on the display module 22 is partially covered with the base unit 41 at the first position P1 and also partially exposed. The distance between the first back end 56 and the first front end 57 of the base unit 41 is smaller than the distance between the bottom end 33 and the top end 34 of the display 11. This enables downsizing of the portable computer 10 with the keyboard module 42 detached.

The keyboard module 42 can be joined with the base unit 41 in the first direction D1 or the second direction D2. During use of the portable computer 10 in the tablet mode, the keyboard 72 is hidden by the display 11 while the keyboard module 42 is joined with the base unit 41 in the second direction D2, for example. As a result, the keyboard 72 is prevented from being erroneously operated. Further, the keyboard 72 is provided in the depression 81a of the second top face 81, therefore, it can be prevented from being pressed by the display 11.

When the keyboard module 42 is joined with the base unit 41 in the first direction D1, the second terminal 107 is electrically connected to the first terminal 102. Thus, it is possible to readily establish an electrical connection between the first terminal 102 and the second terminal 107 by simply joining the keyboard module 42 with the base unit 41.

When the keyboard module 42 is joined with the base unit 41 in the second direction D2, the first terminal 102 and the second terminal 107 are electrically disconnected. This makes it possible to prevent an inappropriate connection between the first terminal 102 and the second terminal 107, such as a connection between the positive electrodes.

The keyboard module 42 includes the second battery 98. The second battery 98 is charged by the base unit 41 through the first terminal 102 and the second terminal 107. As a result, the keyboard module 42 is operable without power supply from an outside and chargeable simply when joined with the base unit 41.

The second side faces 85 of the keyboard module 42 continue to the first side faces 58 of the base unit 41 irrespective of the first direction D1 or the second direction D2 of the keyboard module 42 joined with the base unit 41. This results in preventing deterioration in the physical appearance of the portable computer 10 due to the change in the direction of the keyboard module 42 relative to the base unit 41 between the first direction D1 and the second direction D2.

Moreover, the power button 52 is provided on the first side face 58. As a result, the power button 52 is exposed and not covered with the display 11 irrespective of the first position P1 or the second position P2 of the base unit 41. This enables a simple startup of the portable computer 10.

Further, the keyboard module 42 is supported on the base unit 41 by the fitting-in of the protrusions 101 of the base unit 41 and the recesses 106 of the keyboard module 42. Thereby, the keyboard module 42 is prevented from being unintentionally detached from the base unit 41.

The engagement of the hooks 109 in the recesses 106 with the cutouts 104 of the protrusions 101 helps preventing the keyboard module 42 from being detached from the base unit 41. Accordingly, the keyboard module 42 is prevented from being carelessly detached from the base unit 41.

The keyboard module 42 is provided with the ejection lever 75 that releases the engagement between the cutouts 104 and the hooks 109. The ejection lever 75 is thus located near the keyboard 72 that the user operates. Thereby, the user can readily detach the keyboard module 42 from the base unit 41.

The first front end 57 of the base unit 41 is provided with the protrusions 101. In the tent mode, the protrusions 101 and the top end 34 of the display 11 function to support the portable computer 10. The protrusions 101 on the first front end 57 can prevent the rest of the base unit 41 from hitting the mount face S. In addition, the protrusions 101 can increase the tilt of the display 11 relative to the mount face S.

Further, the first bottom face 55 of the base unit 41 is provided with the air intakes 63. Therefore, the air intakes 63 are not exposed while the portable computer 10 is operated in the clam shell mode, for example. Thereby, it is possible to prevent the deterioration in the physical appearance and operability of the portable computer 10.

When the base unit 41 is at the second position P2, the gap G occurs between the back face 32 of the display 11 and the first bottom face 55 of the base unit 41. In other words, the gap G is in-between the air intakes 63 and the display 11. Accordingly, the air intakes 63 are not closed, so that a decrease in the cooling performance of the portable computer 10 can be avoided.

Further, the first back end 56 of the base unit 41 is provided with the air outtakes 64. The first back end 56 is not closed but exposed when the base unit 41 is at the first position P1 or the second position P2. As a result, the cooling module 93 can readily cool the inside of the second housing 51, e.g., the board 91.

The keyboard module 42 inputs information to the CPU on the board 91 via the first communication module 92 and the second communication module 97. In other words, the keyboard module 42 performs wireless communication. Accordingly, the keyboard module 42 can be readily operated while detached from the base unit 41.

The display module 22 can display images on the screen 22a in such directions that the bottom end 33 is located below the image and that the top end 34 is located below the image. The display module 22, thus, can display an image in an appropriate direction in both of the clam shell mode and the tent mode of the portable computer 10.

According to at least one embodiment described above, the fifth end of the input module is detachably connected to the fourth end of the coupling module that is movably connected to a first module via the hinges. This makes it possible for the electronic apparatus to be used in various forms.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a display comprising a first face, a second face opposite the first face, a first end between the first face and the second face, a second end opposite the first end, and a displaying portion on the first face and configured to display an image;
a base comprising a coupling comprising a third end and a fourth end opposite the third end, and an input comprising a fifth end configured to be detachably connected to the fourth end of the coupling; and
a hinge configured to connect the first end of the display and the third end of the coupling to allow the coupling to move between a first position at which the base covers the displaying portion and a second position at which the base covers the second face.

2. The electronic apparatus of claim 1, wherein, while the input is detached from the coupling, the displaying portion is partially covered with the coupling at the first position and partially exposed.

3. The electronic apparatus of claim 1, wherein
the input comprises a sixth end opposite the fifth end, and
a distance between the first end and the second end of the display is larger than a distance between the third end and the fourth end of the coupling, and substantially equal to a distance between the third end of the coupling and the sixth end of the input connected to the coupling.

4. The electronic apparatus of claim 1, wherein the input comprises a third face on which an operation that is capable of being operated is provided, and a fourth face opposite the third face, and
the input is connected to the coupling in a first direction in which the third face opposes the first face when the coupling is at the first position or in a second direction in which the third face opposes the second face when the coupling is at the second position.

5. The electronic apparatus of claim 4, wherein
the coupling comprises a first terminal on the fourth end,
the input comprises a second terminal on the fifth end, and
the second terminal is electrically connected to the first terminal when the input is connected to the coupling in the first direction.

6. The electronic apparatus of claim 5, wherein the first terminal and the second terminal are electrically disconnected when the input is connected to the coupling in the second direction.

7. The electronic apparatus of claim 6, wherein
the input comprises a battery, and
the coupling connected to the input charges the battery through the first terminal and the second terminal, the first terminal and the second terminal being electrically connected to each other.

8. The electronic apparatus of claim 4, wherein
the coupling comprises two first side faces, and
the input comprises two second side faces, the second side faces continuous with the first side faces both when the input is connected to the coupling in the first direction and when the input is connected to the coupling in the second direction.

9. The electronic apparatus of claim 8, further comprising a starter on one of the first side faces, wherein
the electronic apparatus is started when the starter is being operated.

10. The electronic apparatus of claim 1, wherein
the base comprises a first fitting portion on the fourth end of the coupling and a second fitting portion on the fifth end of the input, the first fitting portion and the second fitting portion configured to fit in each other, and
the input is supported on the coupling by the fitting-in of the first fitting portion and the second fitting portion.

11. The electronic apparatus of claim 10, wherein the base comprises a first engaging portion provided in the first fitting portion and a second engaging portion provided in the second fitting portion, the second engaging portion configured to engage with the first engaging portion to prevent the input from being detached from the coupling.

12. The electronic apparatus of claim 11, wherein the input comprises a releaser that, when operated, releases the second engaging portion from the first engaging portion.

13. The electronic apparatus of claim 10, wherein
the first fitting portion comprises a protrusion,
the second fitting portion comprises a recess in which the protrusion is configured to fit, and
the electronic apparatus is capable of being supported by the protrusion and the second end of the display while the input is detached from the coupling.

14. The electronic apparatus of claim 1, wherein the coupling comprises a fifth face opposing the second face of the display when the coupling is at the second position, and a first vent provided in the fifth face.

15. The electronic apparatus of claim 14, wherein a gap is formed between the second face of the display and the fifth face of the coupling when the coupling is at the second position.

16. The electronic apparatus of claim 14, wherein the coupling comprises a second vent on the third end, and a cooling that absorbs outside air through one of the first vent and the second vent and discharges air through the other of the first vent and the second vent.

17. The electronic apparatus of claim 1, further comprising:
a module provided in the display or the coupling;
a first communication module provided in the display or the coupling; and
a second communication module provided in the input and configured to perform wireless communication with the first communication module, wherein
the input is configured to input information to the module via the first communication module and the second communication module.

18. The electronic apparatus of claim 1, wherein the displaying portion is capable of displaying the image in such a position that the first end is located below the image and in such a position that the second end is located below the image.

19. The electronic apparatus of claim 1, wherein the coupling with the input detached is capable of supporting the display while the coupling is located between a third position and the second position, the third position between the first position and the second position, at which the first end of the display and the third end of the coupling oppose each other.

20. The electronic apparatus of claim 1, wherein the coupling with the input detached is capable of being supported by the second end of the display and the fourth end of the coupling while the coupling is located between a third position and the second position, the third position between the first position and the second position, at which the first end of the display and the third end of the coupling oppose each other.
